(19) United States
(12) Patent Application Publication
(10) Pub. No.: US 2007/0165718 A1
(43) Pub. Date: Jul. 19, 2007

(54) Encoding apparatus, encoding method and program

(75) Inventor: Toru Okazaki, Chiba (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SONY CORPORATION

(21) Appl. No.: 11/653,897

(22) Filed: Jan. 17, 2007

(30) Foreign Application Priority Data
Jan. 18, 2006 (JP) P2006-009883

(51) Int. Cl. H04N 11/02

(52) U.S. Cl. 375/240.16

(57) ABSTRACT

A encoding apparatus which encodes picture data obtained by decoding the encoded data includes a decision means for deciding whether a motion vector is generated or not in the encoding of the picture data based on a motion vector of the encoded data obtained by decoding, a motion vector generating means for generating a motion vector based on the picture data provided that the decision means decides to generate the motion vector and a motion prediction/compensation means for generating prediction picture data using the motion vector generated by the motion vector generating means when the decision means decides to calculate the motion vector, and generating the prediction picture data using the motion vector obtained by decoding when the decision means decides not to calculate the motion vector.

### CROSS REFERENCE TO RELATED APPLICATIONS

The present invention contains subject matter related to Japanese Patent Application JP 2006-009883 filed in the Japanese Patent Office on Jan. 18, 2006, the entire contents of which being incorporated herein by reference.

### BACKGROUND OF THE INVENTION

1. Field of the Invention

The invention relates to an encoding apparatus, an encoding method and a program encoding picture data obtained by decoding encoded data.

2. Description of the Related Art

In recent years, devices compliant with MPEG (Moving Picture Experts Group) methods and the like come into widespread use both in information delivery such as broadcast stations and information reception in homes, in which picture data is treated as digital data, compressed by an orthogonal transform such as a discrete cosine transform and a motion compensation, using redundancy peculiar to picture information for the purpose of efficient transmission and storage of information.

Especially, MPEG2 (ISO/IEC13818-2) is defined as a general-purpose picture encoding method, which is widely used for broad applications for professional use and consumer use in standard at present, covering both interlaced scan picture and progressive scan picture, as well as standard resolution picture and high precision picture.

Using the MPEG 2 compression method enables high compression rate and good picture quality by allocating the code amount (bit rate) of 4 to 8 Mbps in the case of, for example, interlaced scan picture of standard resolution having 720×480 pixels, and 18 to 22 Mbps in the case of interlaced scan picture of high resolution having 1920×1088 pixels.

The MPEG 2 targeted at high-picture quality encoding chiefly adapted to broadcasting, however, it did not target at the encoding amount (bit rate) lower than MPEG1, namely, an encoding method of higher compression rate. With the popularization of portable terminals, it is predicted that needs of such encoding method is increased in future, accordingly, standardization of a MPEG4 encoding method has been achieved. Concerning a picture encoding method, the standard has been approved as an international standard as ISO/IEC14496-2 on December, 1998.

Following the MPEG method, an encoding method called as H.264/AVC (Advanced Video Coding) which realizes further higher compression rate is proposed.

In the H.264/AVC method, motion prediction and motion compensation based on a motion vector are performed in the same way as MPEG2.

In such picture processing apparatuses such as an encoding apparatus, a decoding apparatus for MPEG, H.264/AVC and the like, the motion vector is generated by various kinds of calculation to obtain high encoding efficiency.

The generation of the motion vector is performed, for example, by searching a candidate motion vector in reference picture, which minimizes an accumulated value obtained by accumulating squares of differences, for example in a pixel position in a macroblock of frame picture data, between pixel data of the pixel position and pixel data of a pixel position in frame picture data of a reference picture obtained by the pixel position and the candidate motion vector.

### SUMMARY OF THE INVENTION

However, in the above image processing apparatus of the related art, when the motion vector is generated, the accumulated values of all pixel positions in the macroblock are generated with respect to all candidate motion vectors, therefore, the computing amount becomes huge and processing burden caused by the generation of motion vectors is increased, as a result, there are problems such that real-time realization is difficult and fast transform processing is difficult.

In addition, in the image processing apparatus of the related art, there is a problem that, when the computing amount is reduced by merely simplifying the computing caused by the generation of the motion vector, it is difficult to obtain sufficient encoding efficiency.

In an image processing apparatus in which encoded picture data is received, encoding is performed again in another method and the encoded data is outputted, a part of the encoded picture data is decoded, thereby abstracting a motion vector in the encoded data, and the computing caused by the generation of the motion vector can be saved by using the information. However, even in this case, when encoding methods of encoded data are different in the input side and the output side, kinds of available modes of motion compensation and the like are sometimes different. In the case that there are more kinds of modes and precise motion compensation is possible in the encoding method at the output side where re-encoding is performed, for example, if the motion vector of the inputted encoded data is used as it is, the benefit thereof is not utilized and there arises the problem that sufficient encoding efficiency is difficult to be obtained.

In view of the above, it is desirable to provide an encoding apparatus, an encoding method and a program thereof capable of generating a motion vector with a smaller computing amount as compared to related arts.

According to an embodiment of the invention, there is provided an encoding apparatus which encodes picture data obtained by decoding the encoded data includes a decision means for deciding, based on a motion vector of the encoded data obtained by decoding, whether a motion vector is generated or not in the encoding of the picture data, a motion vector generating means for generating a motion vector based on the picture data provided that the decision means decides to generate the motion vector, and a motion prediction/compensation means for generating prediction picture data using the motion vector generated by the motion vector generating means when the decision means decides to calculate the motion vector, and generating the prediction picture data using the motion vector obtained by decoding when the decision means decides not to calculate the motion vector.

According to an embodiment of the invention, there is provided an encoding method which encodes picture data obtained by decoding the encoded data includes a decision step of deciding, based on a motion vector of the encoded data obtained by decoding, whether a motion vector is generated or not in the encoding of the picture data, a motion vector generating step of generating a motion vector based on the picture data provided that the decision step decides to generate the motion vector, and a motion prediction/compensation step of generating prediction picture data using the motion vector generated by the motion vector generating means when the decision step decides to calculate the motion vector, and generating the prediction picture data using the motion vector obtained by decoding when the decision means decides not to calculate the motion vector.

According to an embodiment of the invention, there is provided a program executed by a computer, which encodes picture data obtained by decoding the encoded data, allowing the computer to execute a decision procedure of deciding, based on a motion vector of the encoded data obtained by decoding, whether a motion vector is generated or not in the encoding of the picture data, a motion vector generating procedure of generating a motion vector based on the picture data provided that the decision procedure decides to generate the motion vector, and a motion prediction/compensation procedure of generating prediction picture data using the motion vector generated by the motion vector generating means when the decision procedure decides to calculate the motion vector, and generating the prediction picture data using the motion vector obtained by decoding when the decision procedure decides not to calculate the motion vector.

According to an embodiment of the invention, it is possible to provide an encoding apparatus, an encoding method and a program thereof capable of generating a motion vector with the smaller computing amount as compared to related arts.

### BRIEF DESCRIPTION OF THE DRAWINGS

FIG. 1 is the whole configuration diagram of a communication system according to a first embodiment of the invention;

FIG. 2 is a configuration diagram of an encoding apparatus 11 shown in FIG. 1;

FIG. 3 is a configuration diagram of a transform apparatus 13 shown in FIG. 1;

FIG. 4 is a flowchart for explaining the processing of a motion-vector utilization decision circuit shown in FIG. 1;

FIG. 5 is a configuration diagram of a decoding apparatus 17 shown in FIG. 1;

FIG. 6 is a configuration diagram of a transform apparatus according to a second embodiment of the invention;

FIG. 7 is a flowchart for explaining a motion-vector utilization decision circuit according to the second embodiment of the invention;

FIG. 8 is a configuration diagram of a transform apparatus according to a third embodiment of the invention;

FIG. 9 is a flowchart for explaining the processing of a motion-vector utilization decision circuit according to the third embodiment of the invention;

FIG. 10 is a flowchart for explaining the processing of a motion-vector utilization decision circuit according to a fourth embodiment of the invention;

FIG. 11 is a flowchart for explaining the processing of a motion-vector utilization decision circuit according to a fifth embodiment of the invention; and

FIG. 12 is a flowchart for explaining the processing of a motion-vector utilization decision circuit according to a sixth embodiment of the invention.

### DESCRIPTION OF THE PREFERRED EMBODIMENTS

Hereinafter, communication systems according to embodiments of the invention will be explained.

### First Embodiment

A first embodiment of the invention will be explained hereinafter.

First, correspondence between components of the embodiment and components of the invention will be explained.

A motion-vector utilization decision circuit 151 is an example of a decision means of the invention, a motion vector generating circuit 143 is an example of a motion vector generating means of the invention and a motion compensation circuit 142 is an example of a motion prediction/compensation means of the invention.

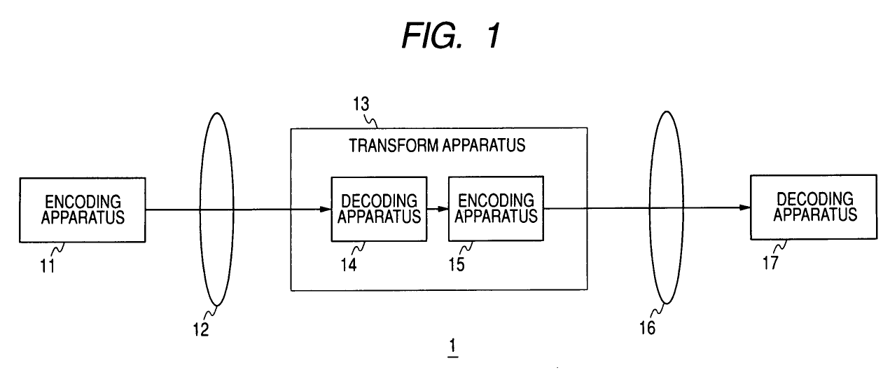

FIG. 1 is the whole configuration diagram of a communication system 1 according to the embodiment of the invention.

As shown in FIG. 1, the communication 1 includes, for example, an encoding apparatus 11, a transform apparatus 13 and a decoding apparatus 17.

### (Encoding Apparatus 11)

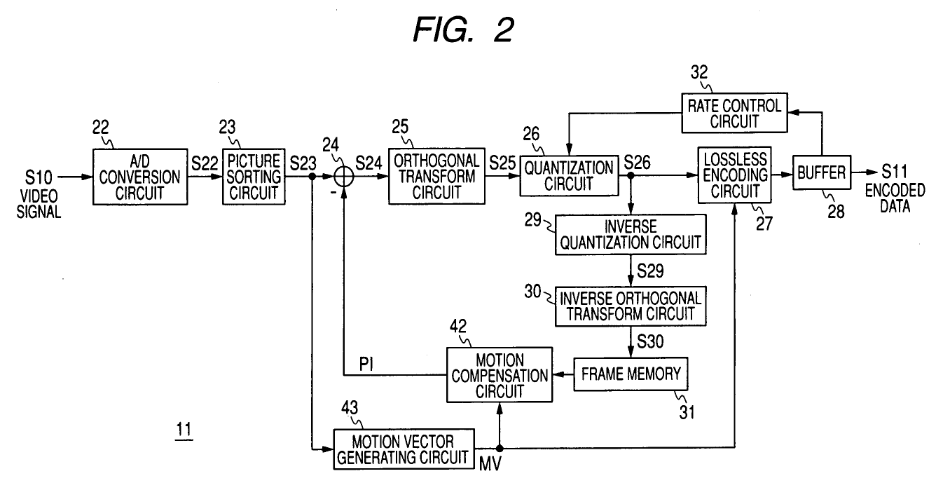

FIG. 2 is a configuration diagram of the encoding apparatus 11 shown in FIG. 1.

The encoding apparatus 11 performs encoding of a MPEG2 method, for example.

As shown in FIG. 2, the encoding apparatus 11 includes, for example, an A/D conversion circuit 22, a picture sorting circuit 23, a computing circuit 24, an orthogonal transform circuit 25, a quantization circuit 26, a lossless encoding circuit 27, a buffer 28, an inverse quantization circuit 29, an inverse orthogonal transform circuit 30, a frame memory 31, a rate control circuit 32, a motion compensation circuit 42, and a motion vector generating circuit 43.

The A/D conversion circuit 22 converts inputted picture data to be encoded S10 including an analog luminance signal Y and color difference signals Pb, Pr into a digital picture data S22, and outputs it to the picture sorting circuit 23.

The picture sorting circuit 23 outputs a picture data S23 to the computing circuit 24 and the motion vector generating circuit 43, in which the picture data S22 inputted from the A/D conversion circuit 22 are sorted in the order to be encoded according to a GOP (Group Of Picture) structure including picture types I, P and B.

The computing circuit 24 generates a picture data S24 showing the difference between the picture data S23 and a prediction picture data PI from the motion compensation circuit 42 and output it to the orthogonal transform circuit 25.

The orthogonal transform circuit 25 generates a picture data (for example, a DCT coefficient) S25 by performing an orthogonal transform such as a discrete cosine transform or a Karhunen-Loeve transform with respect to the picture data S24, outputting it to the quantization circuit 26.

The quantization circuit 26 generates a picture data 26 by quantizing the picture data S25 based on a quantization parameter QP inputted from the rate control circuit S32, using a quantization scale (quantization step) prescribed according to the quantization parameter QP, outputting the picture data S26 to the lossless encoding circuit 27 and the inverse quantization circuit 29.

The lossless encoding circuit 27 stores encoded data in the buffer 28, which is the data obtained by subjecting the picture data S26 to variable length encoding or arithmetic encoding.

At this time, the lossless encoding circuit 27 encodes a motion vector MV inputted from the motion vector generating circuit 43 and stores it into header data of the encoded data.

The encoded data S11 stored in the buffer 28 is transmitted to the transform apparatus 13 through transmission media 12 after modulation and the like are performed.

The transmission media 12 are, for example, a satellite broadcasting wave, a cable TV network, a telephone network, cellular-phone network and the like.

The inverse quantization circuit 29 inversely quantizes the picture data S26 based on the quantization scale used in the quantization circuit 26 and output it to the inverse orthogonal transform circuit 30.

The inverse orthogonal transform circuit 30 performs inverse orthogonal transform corresponding to the orthogonal transform in the orthogonal transform circuit 25 with respect to the inversely quantized picture data inputted from the inverse quantization circuit 29. Then, output of the inverse orthogonal transform circuit 30 and a prediction picture data PI are added to generate a reconstructed data, and the result is written in the frame memory 31.

The rate control circuit 32 decides the quantization parameter QP based on the picture data read out from the buffer 28 and output it to the quantization circuit 26.

The motion compensation circuit 42 generates the prediction picture data PI corresponding to the motion vector MV inputted from the motion vector generating circuit 43 based on a reference picture data REF stored in the frame memory 31, outputting it to the computing circuit 24.

The motion vector generating circuit 43 performs motion prediction processing based on frame data and field data as a unit of block in the picture data S23, deciding the motion vector MV based on the reference picture data REF read out from the frame memory 31.

That is, the motion vector generating circuit 43 decides the motion vector MV which minimizes a difference DIF between the prediction picture data PI prescribed by the motion vector MV and the reference picture data REF, and the picture data S23 with respect to each block, outputting it to the lossless encoding circuit 27 and the motion compensation circuit 42.

### (Transform Apparatus 13)

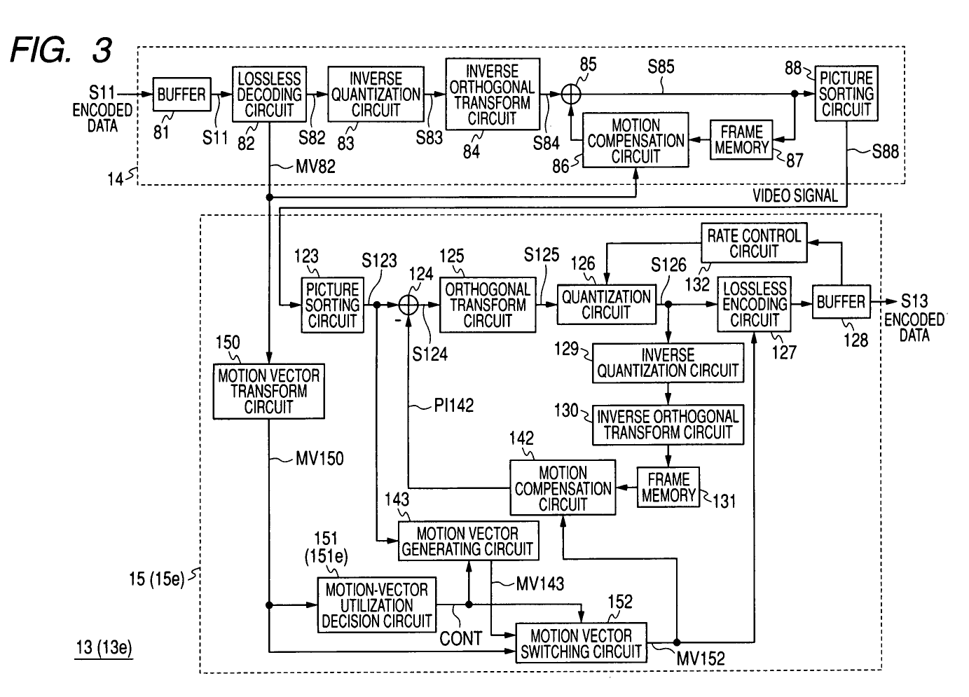

FIG. 3 is a configuration diagram of the transform apparatus 13 shown in FIG. 1.

As shown in FIG. 3, the transform apparatus 13 includes, for example, a decoding apparatus 14 and an encoding apparatus 15.

The decoding apparatus 14 performs decoding of the MPEG2 method, and the encoding apparatus 15 performs encoding of an H.264/AVC method.

First, the decoding apparatus 14 will be explained.

As shown in FIG. 3, the decoding apparatus 14 includes, for example, a buffer 81, a lossless decoding circuit 82, an inverse quantization circuit 83, an inverse orthogonal transform circuit 84, an adding circuit 85, and a motion compensation circuit 86, a frame memory 87 and a picture sorting circuit 88.

The buffer 81 stores the encoded data S11 received from the encoding apparatus 11 shown in FIG. 2 which transmits the data through the transmission media 12.

The lossless decoding circuit 82 generates a picture data S82 by performing variable length decoding or arithmetic decoding to the encoded data S11 read out from the buffer 81, outputting it to the inverse quantization circuit 83.

The lossless decoding circuit 82 also outputs the motion vector MV included in header data of the encoded data S11 to the motion compensation circuit 86 and a motion vector transform circuit 150 of the encoding apparatus 15.

The inverse quantization circuit 83 generates a picture data S83 by inversely quantizing the picture data S82 inputted from the lossless decoding circuit 82 based on the quantization scale stored in header data of the encoded data S11, outputting it to the inverse orthogonal transform circuit 84.

The inverse orthogonal transform circuit 84 generates a picture data S84 by performing inverse orthogonal transform to the picture data S83 inputted from the inverse quantization circuit 83, outputting it to the adding circuit 85.

The adding circuit 85 generates a picture data S85 by adding a prediction picture data PI inputted from the motion compensation circuit 86 and the picture data S84 inputted from the inverse orthogonal transform circuit 84, outputting it to the picture sorting circuit 88 as well as writing it in the frame memory 87.

The motion compensation circuit 86 generates the prediction picture data PI based on the picture data read out from the frame memory 87 and the motion vector MV inputted from the lossless decoding circuit 82, outputting it to the adding circuit 85.

The picture sorting circuit 88 generates a new picture data S88 by sorting respective pictures in the picture data S85 inputted from the adding circuit 85 in display order, outputting it to a picture sorting circuit 123 of the encoding apparatus 15.

Next, the encoding apparatus 15 will be explained.

As shown in FIG. 3, the encoding apparatus 15 includes, for example, the picture sorting circuit 123, a computing circuit 124, an orthogonal transform circuit 125, a quantization circuit 126, a lossless encoding circuit 127, a buffer 128, an inverse quantization circuit 129, an inverse orthogonal transform circuit 130, a frame memory 131, a rate control circuit 132, a motion compensation circuit 142, a motion vector generating circuit 143, a motion vector transform circuit 150, a motion-vector utilization decision circuit 151 and a motion vector switching circuit 152.

The picture sorting circuit 123 outputs a picture data S123 to the computing circuit 124 and the motion vector generating circuit 143, in which the picture data S88 inputted from the decoding apparatus 14 are sorted in the order to be encoded according to the GOP (Group Of Picture) structure including picture types I, P and B.

The computing circuit 124 generates a picture data S124 showing a difference between the picture data S123 and a prediction picture data PI142 from the motion compensation circuit 142, outputting it to the orthogonal transform circuit 125.

The orthogonal transform circuit 125 generates a picture data (for example, a DCT coefficient) S125 by performing an orthogonal transform such as the discrete cosine transform or the Karhunen-Loeve transform with respect to the picture data S124, outputting it to the quantization circuit 126.

The quantization circuit 126 generates a picture data 126 by quantizing the picture data S125 based on a quantization parameter QP inputted from the rate control circuit S132, using a quantization scale (quantization step) prescribed according to the quantization parameter QP, outputting the picture data S126 to the lossless encoding circuit 127 and the inverse quantization circuit 129.

The lossless encoding circuit 127 stores encoded data in the buffer 28, which is the data obtained by performing variable length encoding or arithmetic encoding to the picture data S126.

At this time, the lossless encoding circuit 127 encodes a motion vector MV inputted from the motion vector switching circuit 152 and stores it into header data of the encoded data.

The encoded data S13 stored in the buffer 128 is transmitted to the decoding apparatus 17 through transmission media 16 after modulation and the like are performed.

The inverse quantization circuit 129 inversely quantizes the picture data S126 based on the quantization scale used in the quantization circuit 126 and output it to the inverse orthogonal transform circuit 130.

The inverse orthogonal transform circuit 130 performs inverse orthogonal transform corresponding to the orthogonal transform of the orthogonal transform circuit 125 with respect to the inversely quantized picture data inputted from the inverse quantization circuit 129. Then, output of the inverse orthogonal transform circuit 130 and the prediction picture data PI are added to generate a reconstructed data, and the result is written in the frame memory 31.

The rate control circuit 132 decides the quantization parameter QP based on the picture data read out from the buffer 28 and output it to the quantization circuit 126.

The motion compensation circuit 142 generates the prediction picture data PI142 corresponding to the motion vector MV inputted from the motion vector switching circuit 152 based on a reference picture data REF stored in the frame memory 131, outputting it to the computing circuit 124.

The motion vector generating circuit 143 performs motion prediction processing based on frame data and field data as block units in the picture data S23, deciding a motion vector MV 143 based on the reference picture data REF read out from the frame memory 131.

That is, the motion vector generating circuit 143 decides the motion vector MV143 which minimizing a difference DIF between the prediction picture data PI142 prescribed by the motion vector and the reference picture data REF with respect to each block, and the picture data S123, outputting it to the motion vector switching circuit 152.

In the embodiment, the motion vector generating circuit 143 generates the motion vector MV143 provided that a control signal instructing generation of the motion vector is inputted from the motion-vector utilization decision circuit 151.

The motion vector transform circuit 150 generates a motion vector MV150 by performing transform processing with respect to the motion vector MV inputted from the lossless decoding circuit 82, outputting it to the motion-vector utilization decision circuit 151 and the motion vector switching circuit 152.

The transform processing by the motion vector transform circuit 150 is the processing in which, for example, in the case that a stream of MPEG2 to be decoded is a frame structure and a stream of AVC to be encoded is a field structure, a motion vector extracted from the stream of MPEG2 is transformed into a vector for the field structure. In the frame structure and the field structure, pixels of vertical two macroblocks in the frame structure correspond to pixels of each macroblock of respective fields in the field structure, therefore, the transform processing in such case will be the processing in which a mean value of motion vectors of vertical two macroblocks is taken to be the motion vector of corresponding two macroblocks Therefore, in two macroblocks in the same position at each field of the field structure side, the same motion vector is used at any time. In addition, when comparing the frame structure to the field structure, the vertical size will be half at each picture, therefore, the processing of allowing a value of vertical component of the motion vector to be half is also performed.

The above transform processing is necessary also when the picture frame size is different between the stream to be decoded and the stream to be encoded.

For example, in the case that the picture frame size of the stream to be encoded is half size of the stream to be decoded in vertical and horizontal directions respectively, the motion vector transform circuit 150 allows the motion vector extracted from the stream to be decoded to be half respectively for the stream to be encoded.

In the case of transcode such as when the stream to be decoded is AVC and the stream to be encoded is MPEG2, the precision of the motion vector is higher in AVC, therefore, the processing of rounding the motion vector for MPEG2 will be necessary. AVC can deal with the motion vector up to the quarter pixel precision, whereas MPEG2 can only deal with the motion vector to the half pixel precision. When there is no difference between the decoding side and the encoding side in the structure, the picture frame size, and the precision of the motion vector to be dealt with (or in the case the encoding method of the encoding side can deal with the higher precision), the transform processing is not especially necessary.

The motion-vector utilization decision circuit 151 compares the motion vector of the macroblock which is a target for deciding the motion vector to the motion vector of surrounding macroblocks based on the motion vector MV150 from the motion vector transform circuit 150.

As the result of the above comparison, when the difference of direction and size of the motion vector is within a prescribed range (when a prescribed standard is met), the motion-vector utilization decision circuit 151 outputs a control signal instructing selection of the motion vector from the motion vector transform circuit 150 to the motion vector switching circuit 152.

As the result of the above comparison, when the difference of direction and size of the motion vector is not within a prescribed range, the motion-vector utilization decision circuit 151 outputs a control signal instructing generation of the motion vector to the vector generating circuit 143, and outputs a control signal instructing selection of the motion vector from the motion vector generating circuit 143 to the motion vector switching circuit 152.

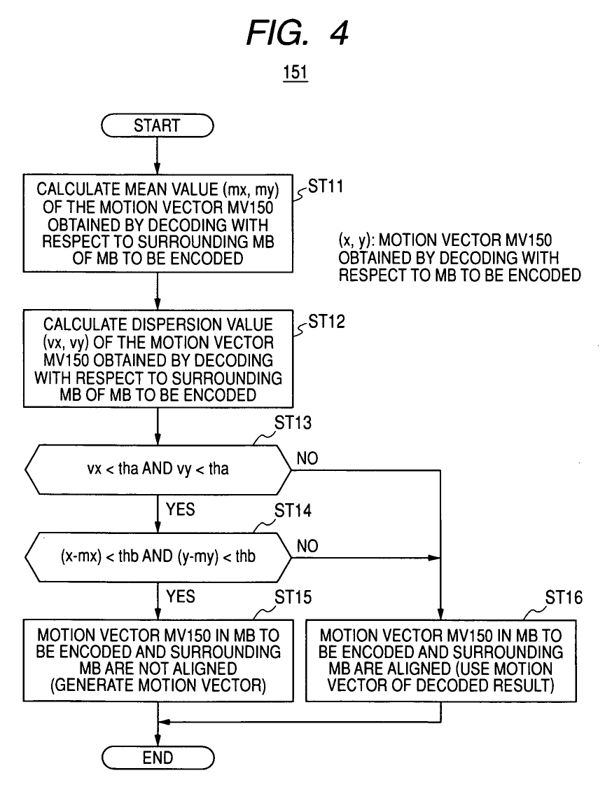

FIG. 4 is a flowchart for explaining the operation of the motion-vector utilization decision circuit 151.

Specifically, the motion-vector utilization decision circuit 151 calculates mean values (mx, my) of the motion vectors of surrounding macroblocks of the macroblock which is a target for deciding the motion vector based on the motion vector MV150 from the motion vector transform circuit 150 (step ST11).

In the embodiment, “surrounding macroblocks of the macroblock which is a target for deciding the motion vector” indicate, for example, four macroblocks, surrounding eight macroblocks or the like located at up and down, right and left of the macroblock which is a target for deciding the motion vector.

In this case, “mx” and “my” can be calculated by formulas “mx=(Σxn)/n”, “my=(Σyn)/n” when the motion vectors of surrounding macroblocks of the macroblock are (x1, y1)(x1, x2) . . . (xn, yn).

The motion-vector utilization decision circuit 151 calculates dispersion values “vx” and “vy” of motion vectors of surrounding macroblocks of the macroblock which is a target for deciding the motion vector, based on the motion vector MV150 from the motion vector transform circuit 150. The motion-vector utilization decision circuit 151 calculates “vx” and “vy” using formulas “vx=Σ((xn−mx)̂2”, “vy=Σ((yn−mx)̂2”, respectively (step ST12).

The motion-vector utilization decision circuit 151 evaluates values of the above “vx” and “vy” and decides whether a first condition that both “vx” and “vy” are smaller than a threshold value “tha” is met or not (step ST13).

The motion-vector utilization decision circuit 151, when deciding that the first condition is met, further compares a motion vector (x, y) of the macroblock which is a target for deciding the motion vector to the mean values (mx, my) of the motion vectors of the surrounding microblocks based on the motion vector MV150 from the motion vector transform circuit 150, judging whether a second condition that both differences are smaller than a certain threshold value “thb” or not (step ST14).

The motion-vector utilization decision circuit 151, when deciding that the second condition is met, decides that the motion vector of the macroblock which is a target for deciding the motion vector and the surrounding motion vectors of the macroblock are aligned. In this case, the motion-vector utilization decision circuit 151 outputs a control signal instructing selection of the motion vector from the motion vector transform circuit 150 to the motion vector switching circuit 152 (step ST15).

On the other hand, the motion-vector utilization decision circuit 151, when deciding that the first condition or the second condition is not met, decides that the motion vector of the macroblock which is a target for deciding the motion vector and the surrounding motion vectors of the macroblock are not aligned. In this case, the motion-vector utilization decision circuit 151 outputs a control signal instructing generation of the motion vector to the motion vector generating circuit 143 and outputs a control signal instructing selection of the motion vector from the motion vector generating circuit 143 to the motion vector switching circuit 152 (step ST16).

The motion vector switching circuit 152 selects one of the motion vector MV 150 from the motion vector transform circuit 150 and the motion vector MV 143 from the motion vector generating circuit 143 based on the control signal from the motion-vector utilization decision circuit 151, outputting it to the lossless encoding circuit 127 and the motion compensation circuit 142 as a motion vector MV152.

### (Decoding Apparatus 17)

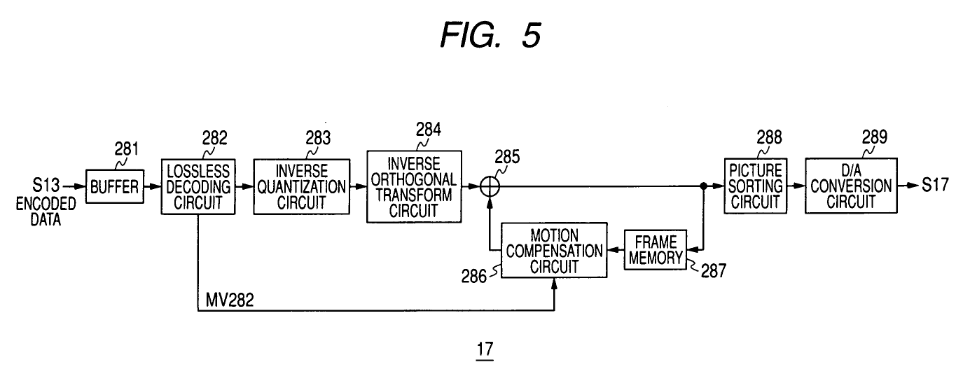

FIG. 5 is a configuration diagram of the decoding apparatus 17 shown in FIG. 1.

The decoding apparatus 17 performs decoding of the H. 264/AVC method.

As shown in FIG. 5, the decoding apparatus 17 includes, for example, a buffer 281, a lossless decoding circuit 282, an inverse quantization circuit 283, an inverse orthogonal transform circuit 284, an adding circuit 285, a motion compensation circuit 286, a frame memory 287, a picture sorting circuit 288 and a D/A conversion circuit 289.

The buffer 281 stores the encoded data S13 received from the transform apparatus 13 shown in FIG. 1 transmitting the data through the transmission media 16.

The lossless decoding circuit 282 generates a picture data S282 by performing a variable length decoding or an arithmetic decoding to the encoded data S13 read out from the buffer 281, outputting it to the inverse quantization circuit 283.

The lossless decoding circuit 282 also outputs a motion vector MV282 included in header data of the encoded data S13 to the motion compensation circuit 286.

The inverse quantization circuit 283 generates a picture data S283 by inversely quantizing the picture data S282 inputted from the lossless decoding circuit 282 based on the quantization scale stored in header data of the encoded data S13, outputting it to the inverse orthogonal transform circuit 284.

The inverse orthogonal transform circuit 284 generates a picture data S284 by performing inverse orthogonal transform to the picture data S283 inputted from the inverse quantization circuit 283, outputting it to the adding circuit 285.

The adding circuit 285 generates a picture data S285 by adding a prediction picture data PI inputted from the motion compensation circuit 286 to the picture data S284 inputted from the inverse orthogonal transform circuit 284, outputting it to the picture sorting circuit 288 and writing it in the frame memory 287.

The motion compensation circuit 286 generates the prediction picture data PI based on the picture data read out from the frame memory 287 and the motion vector MV282 inputted from the lossless decoding circuit 282, outputting it to the adding circuit 285.

The picture sorting circuit 288 generates a new picture data S288 by sorting respective pictures in the picture data S285 inputted from the adding circuit 285 in display order, outputting it to the D/A transform circuit 289.

The D/A transform circuit 289 generates a picture data S17 by sorting the picture data S288 inputted from the picture sorting circuit 288 in display order.

Hereinafter, the whole operation example of the encoding apparatus 11 shown in FIG. 2 will be explained.

The encoding apparatus 11 shown in FIG. 2 generates the encoded data S11 by encoding the picture data S10 by the MPEG2 method.

Then, the encoding apparatus 11 transmits the encoded data S11 to the transform apparatus 13 through the transmission media 12 shown in FIG. 1.

Next, the decoding apparatus 14 of the transform apparatus 13 shown in FIG. 3 performs decoding to the encoded data S11 by the MPEG2 method to generate the picture data S88, outputting it to the encoding apparatus 15.

The encoding apparatus 15 performs encoding to the picture data S88 by the H.264/AVC method.

At this time, the motion-vector utilization decision circuit 151 decides whether using the motion vector MV150 as it is or newly generating the motion vector MB143 in the motion vector generating circuit 143, in the processing of the motion compensation circuit 142 based on the motion vector MV150 which is the decoded result of the decoding apparatus 14.

The motion vector generating circuit 143 generates the motion vector MV143 only when the motion-vector utilization decision circuit 151 decides to generate the motion vector.

As described above, according to the embodiment, the motion-vector utilization decision circuit 151 of the encoding apparatus 15 shown in FIG. 3 selects, based on the motion vector MV150 obtained by decoding, whether the motion vector MV150 is used for encoding as it is or generation of the new motion vector is made to be performed by the motion vector generating circuit 143. Therefore, when the motion-vector utilization decision circuit 151 decides that the motion vector 150 is used for encoding as it is, the processing of generating the motion vector in the motion vector generating circuit 143 becomes unnecessary, as a result, the computing amount of the transform apparatus 13 can be reduced as compared with the one in the past, while maintaining the detecting precision of the motion vector.

### Second Embodiment

A communication system according to an embodiment is the same as the communication system 1 of the first embodiment except a part of the configuration of the transform apparatus 13 shown in FIG. 1.

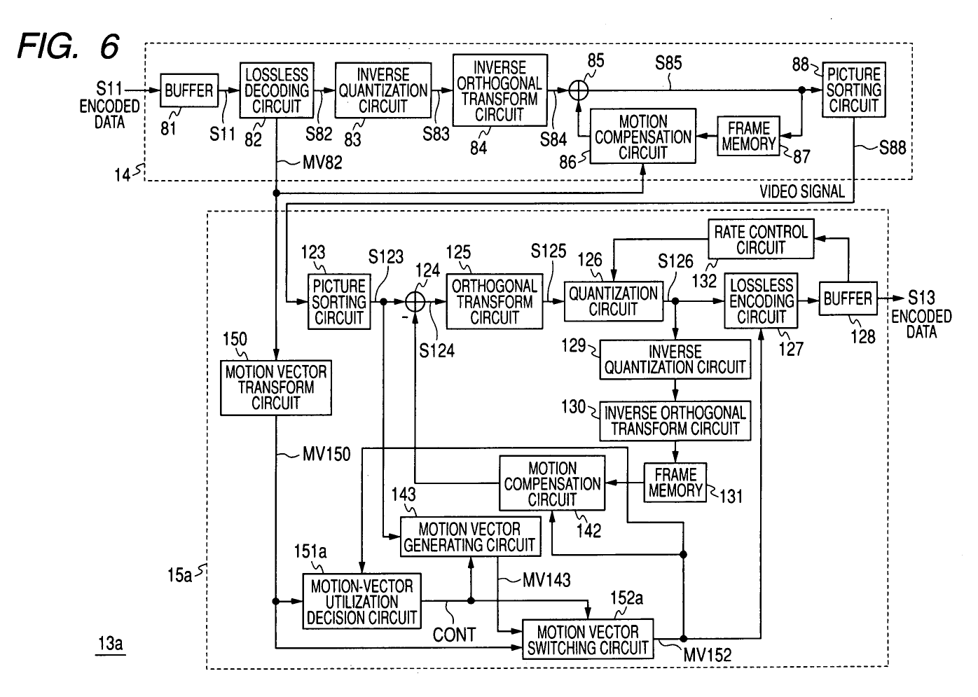

FIG. 6 is a configuration diagram of a transform apparatus 13a according to a second embodiment of the invention.

As shown in FIG. 6, the transform apparatus 13a includes, for example, the decoding apparatus 14 and an encoding apparatus 15a.

The decoding apparatus 14 shown in FIG. 6 is the same as the one explained in the first embodiment.

As shown in FIG. 6, the encoding apparatus 15a includes, for example, the picture sorting circuit 123, the computing circuit 124, the orthogonal transform circuit 125, the quantization circuit 126, the lossless encoding circuit 127, the buffer 128, the inverse quantization circuit 129, the inverse orthogonal transform circuit 130, the frame memory 131, the rate control circuit 132, the motion compensation circuit 142, the motion vector generating circuit 143, the motion vector transform circuit 150, a motion-vector utilization decision circuit 151a and a motion vector switching circuit 152a.

The encoding apparatus 15a has the same configuration as the first embodiment except the motion-vector utilization decision circuit 151a and the motion vector switching circuit 152a.

Hereinafter, the motion-vector utilization decision circuit 151a and the motion vector switching circuit 152a will be explained.

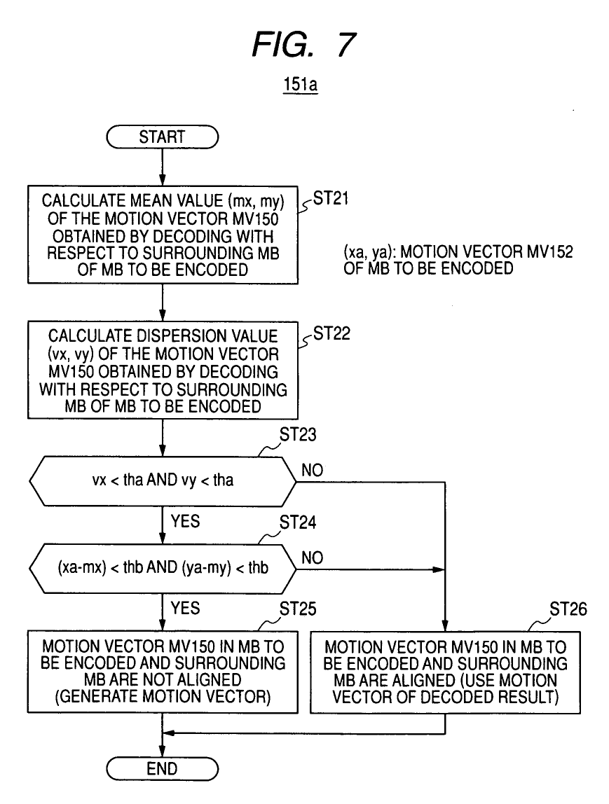

FIG. 7 is a flowchart for explaining the operation of the motion-vector utilization decision circuit 151a.

Firstly, the motion-vector utilization decision circuit 151a calculates, based on the motion vector MV150 from the motion vector transform circuit 150 (step ST21), mean values (mx, my) of motion vectors of surrounding macroblocks of a macroblock which is a target for deciding the motion vector.

In this case, “mx” and “my” can be calculated by formulas “mx=(Σxn)/n”, “my=(Σyn)/n” when the motion vectors of surrounding macroblocks of the macroblock are (x1, y1) (x1, x2) . . . (xn, yn).

The motion-vector utilization decision circuit 151a calculates, based on the motion vector MV150 from the motion vector transform circuit 150, dispersion values “vx” and “vy” of motion vectors of surrounding macroblocks of the macroblock which is a target for deciding the motion vector. The motion-vector utilization decision circuit 151a calculates “vx” and “vy” using formulas “vx=Σ((xn−mx)̂2”, “vy=Σ((yn−mx)̂2”, respectively (step ST22).

The motion-vector utilization decision circuit 151a evaluates values of the above “vx” and “vy” and decides whether a first condition that both “vx” and “vy” are smaller than a threshold value “tha” is met or not (step ST23).

The motion-vector utilization decision circuit 151a, when deciding that the first condition is met, compares the motion vector (xa, ya), obtained based on the motion vector MV152 from the motion vector switching circuit 152a, of the macroblock which is a target for deciding the motion vector to the mean values (mx, my), obtained based on the motion vector MV150 from the motion vector transform circuit 150, of the motion vectors of the surrounding microblocks and decides whether a second condition that both differences are smaller than a certain threshold value “thb” or not (step ST24).

The motion-vector utilization decision circuit 151a, when deciding that the second condition is met, decides that the motion vector of the macroblock which is a target for deciding the motion vector and the surrounding motion vectors of the macroblock are aligned. In this case, the motion-vector utilization decision circuit 151a outputs a control signal instructing selection of the motion vector from the motion vector transform circuit 150 to the motion vector switching circuit 152a (step ST25).

On the other hand, the motion-vector utilization decision circuit 151a, when deciding that the first condition or the second condition is not met, decides that the motion vector of the macroblock which is a target for deciding the motion vector and the surrounding motion vectors of the macroblock are not aligned. In this case, the motion-vector utilization decision circuit 151a outputs a control signal instructing generation of the motion vector to the motion vector generating circuit 143 and outputs a control signal instructing selection of the motion vector from the motion vector generating circuit 143 to the motion vector switching circuit 152a (step ST26).

The motion vector switching circuit 152a selects one of the motion vector MV 150 from the motion vector transform circuit 150 and the motion vector MV143 from the motion vector generating circuit 143 based on the control signal from the motion-vector utilization decision circuit 151a, outputting it to the lossless encoding circuit 127 and the motion compensation circuit 142 as the motion vector MV152.

The motion vector switching circuit 152a outputs the motion vector MV152 to the motion-vector utilization decision circuit 151a.

As described above, according to the embodiment, the motion-vector utilization decision circuit 151a of the encoding apparatus 15a shown in FIG. 6 selects, based on the motion vector MV150 obtained by decoding, whether the motion vector MV150 is used for encoding as it is or generation of a new motion vector is made to be performed by the motion vector generating circuit 143. Therefore, when the motion-vector utilization decision circuit 151a decides that the motion vector 150 is used for encoding as it is, the processing of generating the motion vector in the motion vector generating circuit 143 becomes unnecessary, as a result, the computing amount of the transform apparatus 13 can be reduced as compared with the one in the past.

### Third Embodiment

A communication system according to an embodiment is the same as the communication system 1 of the first embodiment except a part of the configuration of the transform apparatus 13 shown in FIG. 1.

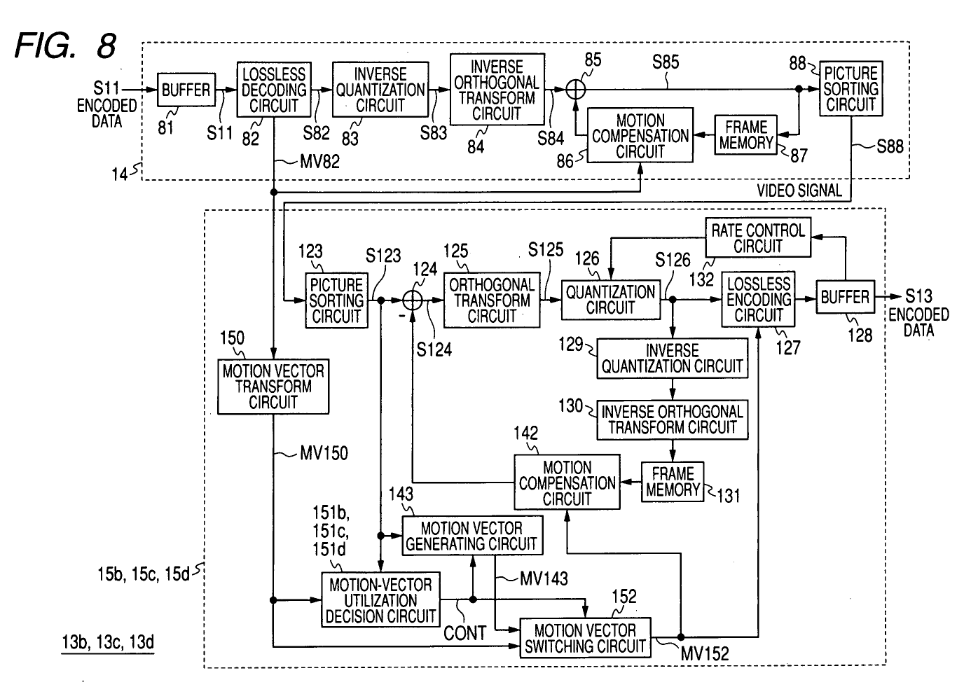

FIG. 8 is a configuration diagram of a transform apparatus 13b according to a third embodiment of the invention.

As shown in FIG. 8, the transform apparatus 13b includes, for example, the decoding apparatus 14 and an encoding apparatus 15b.

The decoding apparatus 14 shown in FIG. 8 is the same as the one explained in the first embodiment.

As shown in FIG. 8, the encoding apparatus 15b includes, for example, the picture sorting circuit 123, the computing circuit 124, the orthogonal transform circuit 125, the quantization circuit 126, the lossless encoding circuit 127, the buffer 128, the inverse quantization circuit 129, the inverse orthogonal transform circuit 130, the frame memory 131, the rate control circuit 132, the motion compensation circuit 142, the motion vector generating circuit 143, the motion vector transform circuit 150, a motion-vector utilization decision circuit 151b.

The encoding apparatus 15b is the same as the first embodiment except the motion-vector utilization decision circuit 151b.

Hereinafter, the motion-vector utilization decision circuit 151b will be explained.

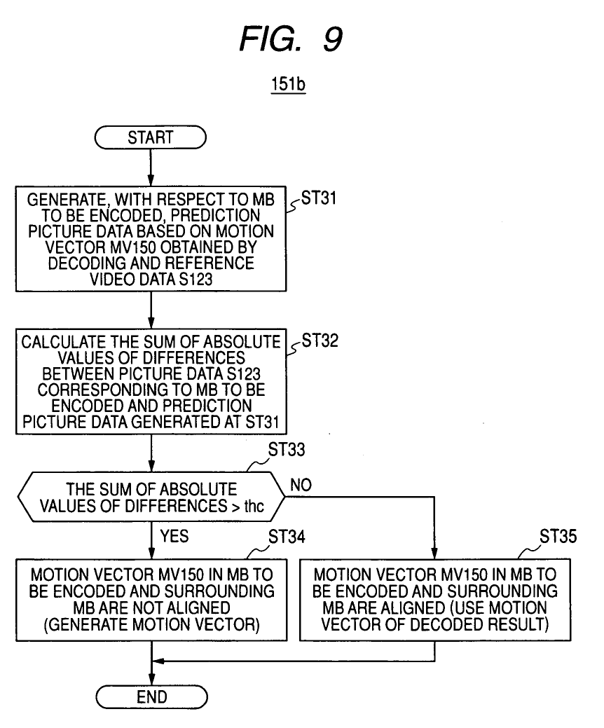

FIG. 9 is a flowchart for explaining the operation of the motion-vector utilization decision circuit 151b.

The motion-vector utilization decision circuit 151b generates a prediction picture data based on the motion vector MV150 (the motion vector corresponding to block data which is a target for encoding) obtained by decoding, which is inputted from the motion vector transform circuit 150, and the reference picture data (picture data S123) used for generating the motion vector MV150 when decoding (ST31).

The motion-vector utilization decision circuit 151b calculates the sum of absolute values of differences of each pixel data between the picture data S123 corresponding to block data which is a target for encoding, which is inputted from the picture sorting circuit 123 and the prediction picture data generated in the step ST31 (step ST32).

The motion-vector utilization decision circuit 151b decides whether the sum of absolute values of differences generated in the step ST32 exceeds a prescribed threshold value “thc” or not (step ST33), and when deciding that it exceeds the threshold value, outputs a control signal indicating generation of the motion vector to the motion vector generating circuit 143 as well as outputs a control signal indicating selection of the motion vector from the motion vector generating circuit 143 to the motion vector switching circuit 152 (step ST34)

On the other hand, the motion-vector utilization decision circuit 151b, when deciding that the sum does not exceed the threshold value in the step S33, outputs a control signal indicating selection of the motion vector from the motion vector transform circuit 150 to the motion vector switching circuit 152 (step ST35).

Also according the embodiment, the same advantages as the first embodiment can be obtained.

### Fourth Embodiment

A communication system according to an embodiment is the same as the communication system 1 of the first embodiment except a part of the configuration of the transform apparatus 13 shown in FIG. 1.

As shown in FIG. 8, the transform apparatus 13c of the embodiment includes, for example, the decoding apparatus 14 and an encoding apparatus 15c.

The decoding apparatus 14 shown in FIG. 8 is the same as the one explained in the first embodiment.

As shown in FIG. 8, the encoding apparatus 15c includes, for example, the picture sorting circuit 123, the computing circuit 124, the orthogonal transform circuit 125, the quantization circuit 126, the lossless encoding circuit 127, the buffer 128, the inverse quantization circuit 129, the inverse orthogonal transform circuit 130, the frame memory 131, the rate control circuit 132, the motion compensation circuit 142, the motion vector generating circuit 143, the motion vector transform circuit 150, a motion-vector utilization decision circuit 151c.

The encoding apparatus 15c is the same as the first embodiment except the motion-vector utilization decision circuit 151c.

Hereinafter, the motion-vector utilization decision circuit 151c will be explained.

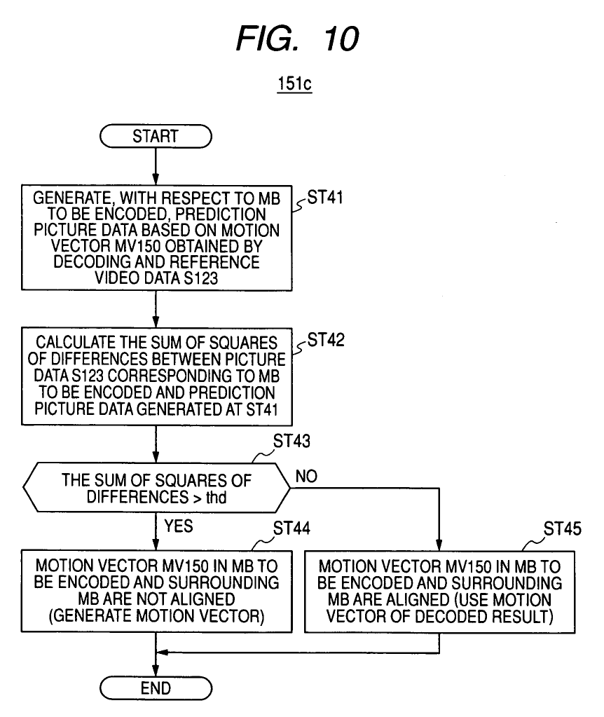

FIG. 10 is a flowchart for explaining the operation of the motion-vector utilization decision circuit 151b.

The motion-vector utilization decision circuit 151c generates a prediction picture data based on the motion vector MV150 (the motion vector corresponding to block data which is a target for encoding) obtained by decoding, which is inputted from the motion vector transform circuit 150 and the reference picture data (picture data S123) used for generating the motion vector MV150 when decoding (ST41).

The motion-vector utilization decision circuit 151c calculates the sum of squares of differences of each pixel data between the picture data S123 corresponding to block data which is a target for encoding, which is inputted from the picture sorting circuit 123 and the prediction picture data generated in the step ST41 (step ST42).

The motion-vector utilization decision circuit 151c decides whether the sum of squares of differences generated in the step ST42 exceeds a prescribed threshold value “thd” or not (step ST43), and when deciding that it exceeds the threshold value, outputs a control signal indicating generation of the motion vector to the motion vector generating-circuit 143 as well as outputs a control signal indicating selection of the motion vector from the motion vector generating circuit 143 to the motion vector switching circuit 152 (step ST44).

On the other hand, the motion-vector utilization decision circuit 151c, when deciding that the sum does not exceed the threshold value in the step S43, outputs a control signal indicating selection of the motion vector from the motion vector transform circuit 150 to the motion vector switching circuit 152 (step ST45).

Also according the embodiment, the same advantages as the first embodiment can be obtained.

### Fifth Embodiment

A communication system according to an embodiment is the same as the communication system 1 of the first embodiment except a part of the configuration of the transform apparatus 13 shown in FIG. 1.

As shown in FIG. 8, the transform apparatus 13d of the embodiment includes, for example, the decoding apparatus 14 and an encoding apparatus 15d.

The decoding apparatus 14 shown in FIG. 8 is the same as the one explained in the first embodiment.

As shown in FIG. 8, the encoding apparatus 15d includes, for example, the picture sorting circuit 123, the computing circuit 124, the orthogonal transform circuit 125, the quantization circuit 126, the lossless encoding circuit 127, the buffer 128, the inverse quantization circuit 129, the inverse orthogonal transform circuit 130, the frame memory 131, the rate control circuit 132, the motion compensation circuit 142, the motion vector generating circuit 143, the motion vector transform circuit 150, a motion-vector utilization decision circuit 151d.

The encoding apparatus 15d is the same as the first embodiment except the motion-vector utilization decision circuit 151d.

Hereinafter, the motion-vector utilization decision circuit 151d will be explained.

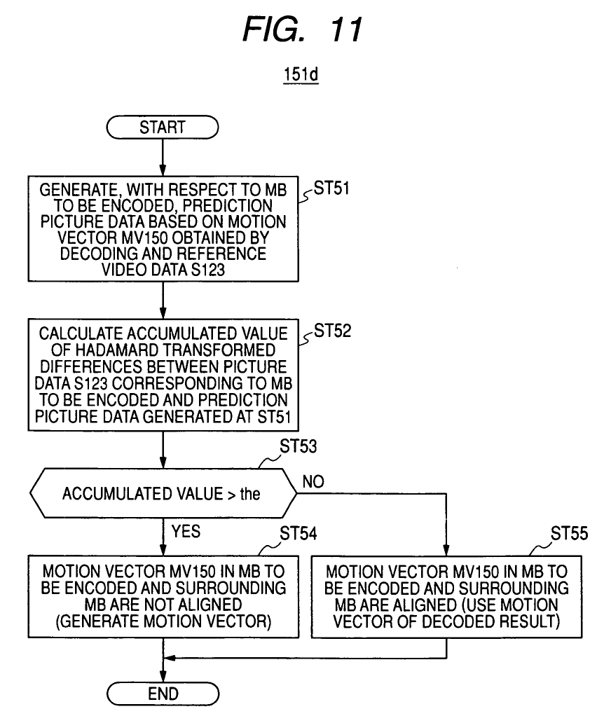

FIG. 11 is a flowchart for explaining the operation of the motion-vector utilization decision circuit 151d.

The motion-vector utilization decision circuit 151d generates a prediction picture data based on the motion vector MV150 (the motion vector corresponding to block data which is a target for encoding) obtained by decoding, which is inputted from the motion vector transform circuit 150 and a reference picture data (picture data S123) used for generating the motion vector MV150 when decoding (ST51).

The motion-vector utilization decision circuit 151d calculates an accumulated value as a result of performing the Hadamard transform with respect to differences of each pixel data between the picture data S123 corresponding to block data which is a target for encoding, which is inputted from the picture sorting circuit 123 and the prediction picture data generated in the step ST51 (step ST52).

The motion-vector utilization decision circuit 151d decides whether the accumulated value generated in the step ST52 exceeds a prescribed threshold value “the” or not (step ST53), and when deciding that it exceeds the threshold value, outputs a control signal indicating generation of the motion vector to the motion vector generating circuit 143 as well as outputs a control signal indicating selection of the motion vector from the motion vector generating circuit 143 to the motion vector switching circuit 152 (step ST54).

On the other hand, the motion-vector utilization decision circuit 151d, when deciding that the sum does not exceed the threshold value in the step S53, outputs a control signal indicating selection of the motion vector from the motion vector transform circuit 150 to the motion vector switching circuit 152 (step ST55).

Also according the embodiment, the same advantages as the first embodiment can be obtained.

### Sixth Embodiment

A communication system according to an embodiment is the same as the communication system 1 of the first embodiment except a part of the configuration of the transform apparatus 13 shown in FIG. 1.

As shown in FIG. 3, the transform apparatus 13e of the embodiment includes, for example, the decoding apparatus 14 and an encoding apparatus 15e.

The decoding apparatus 14 shown in FIG. 3 is the same as the one explained in the first embodiment.

As shown in FIG. 3, the encoding apparatus 15e includes, for example, the picture sorting circuit 123, the computing circuit 124, the orthogonal transform circuit 125, the quantization circuit 126, the lossless encoding circuit 127, the buffer 128, the inverse quantization circuit 129, the inverse orthogonal transform circuit 130, the frame memory 131, the rate control circuit 132, the motion compensation circuit 142, the motion vector generating circuit 143, the motion vector transform circuit 150, a motion-vector utilization decision circuit 151e.

The encoding apparatus 15e is the same as the first embodiment except the motion-vector utilization decision circuit 151e.

Hereinafter, the motion-vector utilization decision circuit 151e will be explained.

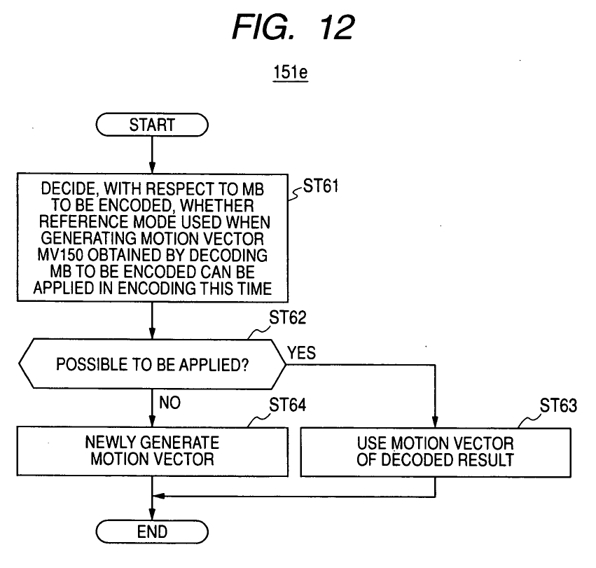

FIG. 12 is a flowchart for explaining the operation of the motion-vector utilization decision circuit 151e.

The motion-vector utilization decision circuit 151e decides whether a reference mode used for generating the motion vector MV150 when decoding can be also applied to the motion compensation circuit 142 or not based on the motion vector MV150 (the motion vector corresponding to block data which is a target for encoding) obtained by decoding, which is inputted from the motion vector transform circuit 150, or decoding information inputted from the lossless decoding circuit 82. The reference mode prescribes, for example, the size of block data for generating the motion vector, a compression method (a compression method which only deals with I, P pictures or a compression method which deals with I, P, and B pictures) and the like.

The motion-vector utilization decision circuit 151e decides that the reference mode used for generating the motion vector MV150 when decoding can be applied to the motion compensation circuit 142, proceeds to the step ST63, otherwise proceeds to the step ST64 (step ST62).

The motion-vector utilization decision circuit 151e, when deciding that the reference mode used for generating the motion vector MV150 when decoding can be applied to the motion compensation circuit 142, outputs a control signal instructing selection of the motion vector from the motion vector transform circuit 150 to the motion vector switching circuit 152 (step ST63).

On the other hand, the motion-vector utilization decision circuit 151e, when deciding that the reference mode used for generating the motion vector MV150 when decoding is difficult to be applied to the motion compensation circuit 142, outputs a control signal instructing generation of the motion vector to the motion vector generating circuit 143, as well as outputs a control signal instructing selection of the motion vector from the motion vector generating circuit 143 to the motion vector switching circuit 152 (step S64).

Also according the embodiment, the same advantages as the first embodiment can be obtained.

The invention is not limited to the above embodiments.

It should be understood by those skilled in the art that various modifications, combinations, sub-combinations and alterations may occur concerning components of the above embodiments insofar as they are within the technical scope or the equivalents thereof.

In the specification, the steps of describing the program include not only processing performed in time series along the written order but also include processing not always performed in time series but executed in parallel or individually.

In the above embodiments, the case is exemplified, in which encoded data of MPEG2 is encoded by H. 264/AVC after it is decoded, however, the encoding method is not particularly limited insofar as the method uses motion vectors.

Also in the above embodiments, the case is exemplified, in which functions such as the encoding apparatus 15 and the like are realized as circuits, however, it is also preferable to realize all or a part of functions of these circuits in a manner that a processing circuit (CPU) execute a program. In this case, the processing circuit is an example of a computer of the invention, and a program is an example of a program of the invention.

It should be understood by those skilled in the art that various modifications, combinations, sub-combinations and alterations may be occur depending on design requirements and other factors insofar as they are within the scope of the appended claims or the equivalents thereof.

What is claimed is:

1. A encoding apparatus which encodes picture data obtained by decoding the encoded data, comprising:
a decision means for deciding, based on a motion vector of the encoded data obtained by decoding, whether a motion vector is generated or not in the encoding of the picture data;
a motion vector generating means for generating a motion vector based on the picture data provided that the decision means decides to generate the motion vector; and
a motion prediction/compensation means for generating prediction picture data using the motion vector generated by the motion vector generating means when the decision means decides to calculate the motion vector, and generating the prediction picture data using the motion vector obtained by decoding when the decision means decides not to calculate the motion vector.

2. The encoding apparatus according to claim 1,
wherein the motion vector generating means generates the motion vector as a unit of block data, and
wherein the decision means decides not to generate the motion vector in the encoding when both a first condition in which dispersion values of motion vectors obtained by the decoding with respect to surrounding block data of a block data which is a target for encoding are smaller than a first prescribed value, and a second condition in which differences between mean values of motion vectors obtained by decoding with respect to the surrounding block data and the motion vector obtained by the decoding with respect to block data which is a target for encoding are smaller than a second prescribed value are met.

3. The encoding apparatus according to claim 1,
wherein the motion vector generating means generates the motion vector as a unit of block data, and
wherein the decision means decides not to generate the motion vector in the encoding when both a first condition in which dispersion values of motion vectors already used in the motion prediction/compensation means with respect to surrounding block data of block data which is a target for encoding are smaller than a first prescribed value, and a second condition in which differences between mean values of motion vectors already used in the motion prediction/compensation means with respect to the surrounding block data and the motion vector obtained by the decoding with respect to block data which is a target for encoding is smaller than a second prescribed value are met.

4. The encoding apparatus according to claim 1,
wherein the decision means generates prediction picture data based on the motion vector obtained by decoding with respect to block data which is a target for encoding and reference picture data used for generating the motion vector in the picture data, and decides, based on the difference between the prediction picture data and the block data which is a target for encoding, whether a motion vector is generated or not in the encoding.

5. The encoding apparatus according to claim 4,
wherein the decision means calculates an accumulated value by accumulating absolute values of differences of corresponding pixel data between the prediction picture data and the block data which is a target for encoding, and when the accumulated value is smaller than a prescribed value, decides not to generate the motion vector.

6. The encoding apparatus according to claim 4,
wherein the decision means calculates the sum of squares of differences of corresponding pixel data between the prediction picture data and the block data which is a target for encoding, and when the sum of squares is smaller than a prescribed value, decides not to generate the motion vector.

7. The encoding apparatus according to claim 4,
wherein the decision means calculates an accumulated value by accumulating differences of corresponding picture data after the Hadamard transform is performed, between the prediction picture data and the block data which is a target for encoding, and when the accumulated value is smaller than a prescribed value, decides not to generated the motion vector.

8. The encoding apparatus according to claim 1,
wherein the decision means decides whether it is possible to apply a reference mode in the encoding, which has been used when generating the motion vector of the encoded data obtained by decoding, and when deciding that it is not possible to apply the mode, decides to generate a motion vector in the encoding of the picture data.

9. The encoding apparatus according to claim 1,
wherein an encoding method applied when generating the encoded data is different from an encoding method used when encoding the picture data.

10. An encoding method which encodes picture data obtained by decoding the encoded data, comprising:
a decision step of deciding, based on a motion vector of the encoded data obtained by decoding, whether a motion vector is generated or not in the encoding of the picture data;
a motion vector generating step of generating a motion vector based on the picture data provided that the decision step decides to generate the motion vector; and
a motion prediction/compensation step of generating prediction picture data using the motion vector generated by the motion vector generating means when the decision step decides to calculate the motion vector, and generating the prediction picture data using the motion vector obtained by decoding when the decision means decides not to calculate the motion vector.

11. A program executed by a computer, which encodes picture data obtained by decoding the encoded data, allowing the computer to execute
a decision procedure of deciding, based on a motion vector of the encoded data obtained by decoding, whether a motion vector is generated or not in the encoding of the picture data, a motion vector generating procedure of generating a motion vector based on the picture data provided that the decision procedure decides to generate the motion vector, and a motion prediction/compensation procedure of generating prediction picture data using the motion vector generated by the motion vector generating means when the decision procedure decides to calculate the motion vector, and generating the prediction picture data using the motion vector obtained by decoding when the decision procedure decides not to calculate the motion vector.

12. A encoding apparatus which encodes picture data obtained by decoding the encoded data, comprising:
a decision unit configured to decide, based on a motion vector of the encoded data obtained by decoding, whether a motion vector is generated or not in the encoding of the picture data;
a motion vector generating unit configured to generate a motion vector based on the picture data provided that the decision unit decides to generate the motion vector; and
a motion prediction/compensation unit configured to generate prediction picture data using the motion vector generated by the motion vector generating unit when the decision unit decides to calculate the motion vector, and generating the prediction picture data using the motion vector obtained by decoding when the decision unit decides not to calculate the motion vector.
